(19) United States
(12) Patent Application Publication
(10) Pub. No.: US 2017/0290453 A1
(43) Pub. Date: Oct. 12, 2017

(54) Interlocking Cookware Assembly

(71) Applicant: Diane Pittman, Selma, NC (US)

(72) Inventor: Diane Pittman, Selma, NC (US)

(21) Appl. No.: 15/095,813

(22) Filed: Apr. 11, 2016

(51) Int. Cl. A47J 27/13; A47J 36/06; A47J 36/20; A47J 45/06

(52) U.S. Cl. CPC A47J 27/13; A47J 45/06; A47J 36/06; A47J 36/20

(57) ABSTRACT

An interlocking cookware assembly that is interlocking and stackable includes a plurality of pots. Each pot comprises an annular wall that defines a top, which is open, and a bottom, which is closed. A first threaded section is positioned on an interior of the annular wall adjacent to the top. A second threaded section, complementary to the first threaded section, is positioned on an exterior of the annular wall adjacent to the bottom. A first handle is coupled to the annular wall proximate to the top. A lid, which is complementary to the top, is selectively couplable to each of the plurality of pots. A second handle is coupled to the lid. The first threaded sections are positioned to threadedly couple to respective second threaded sections, wherein the plurality of pots is mutually coupled in a vertical configuration. The lid is positioned to couple to a respective first threaded section.

### BACKGROUND OF THE DISCLOSURE

### Field of the Disclosure

The disclosure relates to cookware assemblies and more particularly pertains to a new cookware assembly that is interlocking and stackable.

### SUMMARY OF THE DISCLOSURE

An embodiment of the disclosure meets the needs presented above by generally comprising a plurality of pots. Each pot comprises an annular wall that defines a top, which is open, and a bottom, which is closed. A first threaded section is positioned on an interior of the annular wall adjacent to the top. A second threaded section, complementary to the first threaded section, is positioned on an exterior of the annular wall adjacent to the bottom. A first handle is coupled to the annular wall proximate to the top. A lid, which is complementary to the top, is selectively couplable to each of the plurality of pots. A second handle is coupled to the lid. The first threaded sections are positioned to threadedly couple to respective second threaded sections, wherein the plurality of pots is mutually coupled in a vertical configuration. The lid is positioned to couple to a respective first threaded section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of an interlocking cookware assembly according to an embodiment of the disclosure.

FIG. 2 is a top view of an embodiment of the disclosure.

FIG. 3 is an isometric perspective view of an embodiment of the disclosure.

FIG. 4 is an isometric perspective view of an embodiment of the disclosure.

FIG. 5 is an isometric perspective view of an embodiment of the disclosure.

FIG. 6 is an isometric perspective view of an embodiment of the disclosure.

FIG. 7 is a top view of an embodiment of the disclosure.

### DESCRIPTION OF THE PREFERRED EMBODIMENT

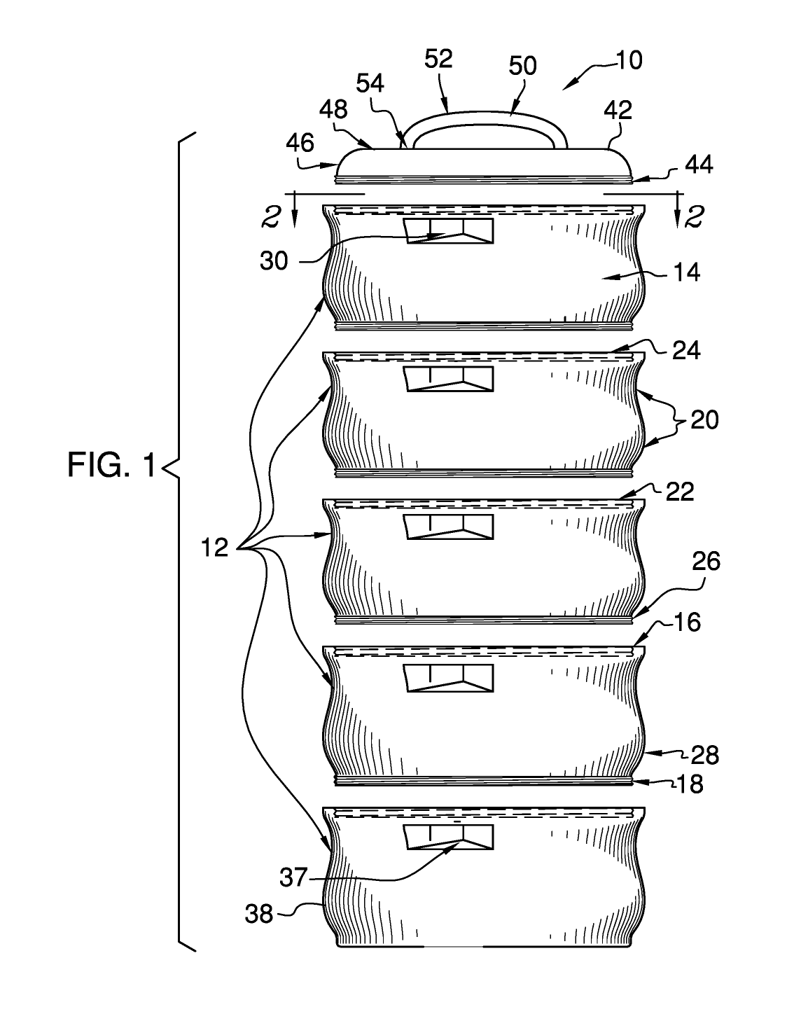

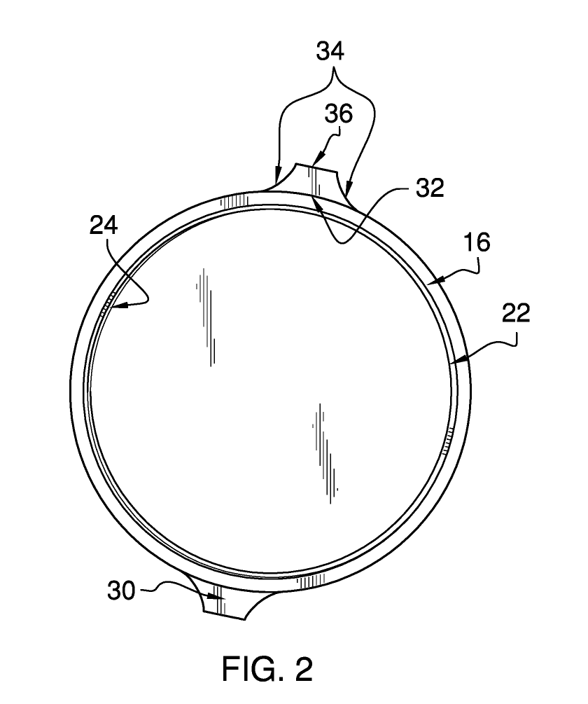

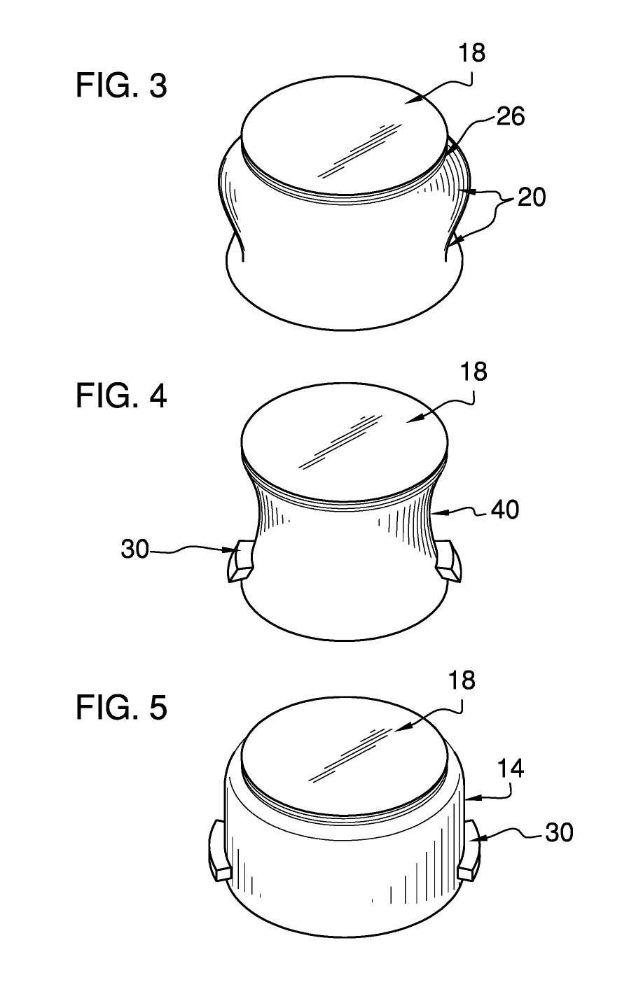

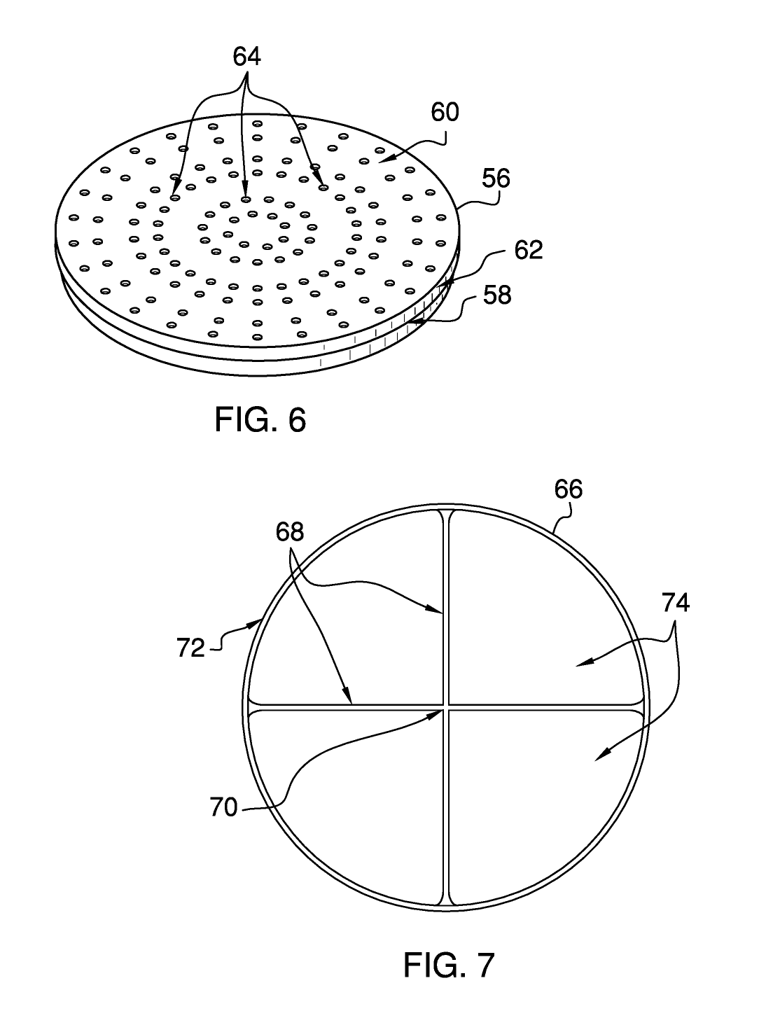

With reference now to the drawings, and in particular to FIGS. 1 through 7 thereof, a new cookware assembly embodying the principles and concepts of an embodiment of the disclosure and generally designated by the reference numeral 10 will be described.

As best illustrated in FIGS. 1 through 7, the interlocking cookware assembly 10 generally comprises a plurality of pots 12. Each pot 12 comprises an annular wall 14 that defines a top 16 and a bottom 18. The top 16 is open and the bottom 18 is closed. The top 16 and the bottom 18 are circular. In one embodiment, the annular wall 14 comprises a pair of opposing arcuate sections 20, such that the annular wall 14 is dimensionally larger proximate to the bottom 18 than proximate to the top 16.

A first threaded section 22 is positioned on an interior 24 of the annular wall 14 adjacent to the top 16. A second threaded section 26 is positioned on an exterior 28 of the annular wall 14 adjacent to the bottom 18. The second threaded section 26 is complementary to the first threaded section 22.

A first handle 30 is coupled to the annular wall 14 proximate to the top 16. In one embodiment, the first handle 30 comprises a pair of first handles 30 that are opposingly positioned on the annular wall 14. Each of the pair of first handles 30 comprises a first face 32 coupled to the annular wall 14, opposing side faces 34 that extend arcuately from the annular wall 14 to a second face 36 of the first handle 30, and a bottom face 37 that is recessed. The bottom face 37 is positioned on the first handle 30 such that the first handle 30 is configured for grasping in the hand of the user with the fingers of the hand positioned on the bottom face 37.

The plurality of pots 12 comprises from two to eight pots 12. The plurality of pots 12 comprises from four to six pots 12. The plurality of pots 12 comprises five pots 12.

In one embodiment, the plurality of pots 12 comprises a base pot 38. The second threaded section 26 of the base pot 38 is leveled, such that the bottom 18 of the base pot 38 is not couplable to the top 16 of the respective pot 12.

In another embodiment, at least one pot of the plurality of pots 12 has the annular wall 14 extending arcuately from the top 16 to the bottom 18. The annular wall 14 is dimensionally narrower proximate to a midpoint 40 of the annular wall 14 than adjacent to the top 16 and the bottom 18. In yet another embodiment, at least one pot of the plurality of pots 12 has the annular wall 14 extending linearly from the top 16 to the bottom 18.

The assembly 10 also comprises a lid 42 that is complementary to the top 16. The lid 42 is selectively couplable to each of the plurality of pots 12. The lid 42 comprises tempered glass. The lid 42 comprises an annular rim 44 that is threaded. The annular rim 44 is complementary to the first threaded sections 22 of the plurality of pots 12. A side face 46 extends upwardly from the annular rim 44. The side face 46 is arcuate. An upper face 48 is coupled to and extends inwardly from the side face 46.

A second handle 50 is coupled to the lid 42. The second handle 50 is positioned on the lid 42 such that the second handle 50 is configured for grasping in a hand of a user. The lid 42 is rotatable relative to the top 16 of a respective pot 12 such that the lid 42 is coupled to the respective pot 12. The second handle 50 comprises an arm 52. The arm 52 has opposing ends 54. Each opposing end 54 is coupled to the lid 42. The arm 52 is arcuate. The second handle 50 is substantially centrally positioned on the upper face 48 of the lid 42.

The assembly 10 also comprises a first insert 56 that is complementary to the top 16. The first insert 56 comprises an annular lip 58 and a plate 60. The plate 60 is coupled to an upper edge 62 of the annular lip 58. The plate 60 comprises a plurality of penetrations 64. The top 16 is positioned for insertion of the first insert 56 into a respective pot 12. The annular lip 58 is positioned to rest on the bottom 18 of the respective pot 12. The plate 60 is positioned above the bottom 18 in substantial parallelism with the bottom 18. The plurality of penetrations 64 are positioned in the plate 60 such that the penetrations 64 are configured to allow steam to pass through the plate 60.

The assembly 10 also comprises a second insert 66 that is complementary to the top 16. The second insert 66 comprises a plurality of partitions 68 that are mutually coupled at and extend from a center point 70 of the second insert 66 to a ring 72. The ring 72 and the partitions 68 define a plurality of compartments 74. The ring 72 and the partitions 68 extend from the bottom 18 to proximate to the top 16 of a respective pot 12 when the second insert 66 is positioned in the respective pot 12. The top 16 is positioned for insertion of the second insert 66 into a respective pot 12 such that the second insert 66 rests on the bottom 18 of the respective pot 12. The partitions 68 are positioned in the ring 72 such that the second insert 66 is configured for addition of food items into the compartments 74. The food items are prevented from mixing. In one embodiment, the plurality of partitions 68 comprises four partitions 68 that are evenly spaced within the ring 72.

In use, the first threaded sections 22 of the plurality of pots 12 are positioned such that respective second threaded sections 26 are positioned to threadedly couple to respective first threaded sections 22. The plurality of pots 12 are mutually coupled in a vertical configuration. The lid 42 is positioned to couple to a respective first threaded section 22 such that the second handle 50 is configured for the user to lift the plurality of pots 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An interlocking cookware assembly comprising:
a plurality of pots, each said pot comprising:
an annular wall defining a top and a bottom, said top being open, said bottom being closed, said top and said bottom being circular,
a first threaded section positioned on an interior of said annular wall adjacent to said top,
a second threaded section positioned on an exterior of said annular wall adjacent to said bottom, said second threaded section being complementary to said first threaded section, and
a first handle coupled to said annular wall proximate to said top;
a lid complementary to said top, said lid being selectively couplable to each of said plurality of pots;
a second handle coupled to said lid, wherein said second handle is positioned on said lid such that said second handle is configured for grasping in a hand of a user, such that said lid is rotatable relative to said top of a respective said pot such that said lid is coupled to said respective said pot;
wherein said first threaded sections of said plurality of pots are positioned such that respective said second threaded sections are positioned to threadedly couple to respective said first threaded sections such that said plurality of pots are mutually coupled in a vertical configuration, wherein said lid is positioned to couple to a respective said first threaded section such that said second handle is configured for the user to lift said plurality of pots.

2. The assembly of claim 1, further including said annular wall comprising a pair of opposing arcuate sections, wherein said annular wall is dimensionally larger proximate to said bottom than proximate to said top.

3. The assembly of claim 1, further including said first handle comprising a pair of first handles opposingly positioned on said annular wall, each of said pair of first handles comprising:
a first face coupled to said annular wall;
opposing side faces extending arcuately from said annular wall to a second face of said first handle;
a bottom face, said bottom face being recessed; and
wherein said bottom face is positioned on said first handle such that said first handle is configured for grasping in the hand of the user with the fingers of the hand being positioned on said bottom face.

4. The assembly of claim 1, further including said plurality of pots comprising from two to eight said pots.

5. The assembly of claim 4, further including said plurality of pots comprising from four to six said pots.

6. The assembly of claim 5, further including said plurality of pots comprising five said pots.

7. The assembly of claim 1, further including said plurality of pots comprising a base pot, said second threaded section of said base pot being leveled, such that said bottom of said base pot is not couplable to said top of said respective said pot.

8. The assembly of claim 1, further including said lid comprising tempered glass.

9. The assembly of claim 1, further including said lid comprising:
an annular rim, said annular rim being threaded, said annular rim being complementary to said first threaded sections of said plurality of pots;
a side face extending upwardly from said annular rim, said side face being arcuate; and
an upper face coupled to and extending inwardly from said side face.

10. The assembly of claim 9, further including said second handle comprising an arm, said arm having opposing ends, each said opposing end being coupled to said lid, said arm being arcuate, said second handle being substantially centrally positioned on said upper face of said lid.

11. The assembly of claim 1, further including a first insert complementary to said top, said first insert comprising an annular lip and a plate, said plate being coupled to a upper edge of said annular lip, said plate comprising a plurality of penetrations, wherein said top is positioned for inserting said first insert into a respective said pot such that said annular lip is positioned for resting on said bottom of said respective said pot, wherein said plate is positioned above said bottom in substantial parallelism with said bottom, such that said plurality of penetrations are positioned in said plate such that said penetrations are configured to allow steam to pass through said plate.

12. The assembly of claim 1, further including a second insert complementary to said top, said second insert comprising a plurality of partitions mutually coupled at and extending from a center point of said second insert to a ring defining a plurality of compartments, said ring and said partitions extending from said bottom to proximate to said top of a respective said pot when said second insert is positioned in said respective said pot, wherein said top is positioned for inserting said second insert into a respective said pot such that said second insert rests on said bottom of said respective said pot, wherein said partitions are positioned in said ring such that said second insert is configured for addition of food items into said compartments such that the food items are prevented from mixing.

13. The assembly of claim 12, further including said plurality of partitions comprising four said partitions evenly spaced within said ring.

14. The assembly of claim 1, further including at least one said pot of said plurality of pots having said annular wall extending arcuately from said top to said bottom, wherein said annular wall is dimensionally narrower proximate to a midpoint of said annular wall than adjacent to said top and said bottom.

15. The assembly of claim 1, further including at least one said pot of said plurality of pots having said annular wall extending linearly from said top to said bottom.

16. An interlocking cookware assembly comprising:
a plurality of pots, each said pot comprising:
an annular wall defining a top and a bottom, said top being open, said bottom being closed, said top and said bottom being circular, said annular wall comprising a pair of opposing arcuate sections, wherein said annular wall is dimensionally larger proximate to said bottom than proximate to said top,
a first threaded section positioned on an interior of said annular wall adjacent to said top,
a second threaded section positioned on an exterior of said annular wall adjacent to said bottom, said second threaded section being complementary to said first threaded section,
a first handle coupled to said annular wall proximate to said top, said first handle comprising a pair of first handles opposingly positioned on said annular wall, each of said pair of first handles comprising:
a first face coupled to said annular wall,
opposing side faces extending arcuately from said annular wall to a second face of said first handle,
a bottom face, said bottom face being recessed, and
wherein said bottom face is positioned on said first handle such that said first handle is configured for grasping in the hand of the user with the fingers of the hand being positioned on said bottom face;
said plurality of pots comprising from two to eight said pots, said plurality of pots comprising from four to six said pots, said plurality of pots comprising five said pots;
said plurality of pots comprising a base pot, said second threaded section of said base pot being leveled, such that said bottom of said base pot is not couplable to said top of said respective said pot;
at least one said pot of said plurality of pots having said annular wall extending arcuately from said top to said bottom, wherein said annular wall is dimensionally narrower proximate to a midpoint of said annular wall than adjacent to said top and said bottom;
at least one said pot of said plurality of pots having said annular wall extending linearly from said top to said bottom;
a lid complementary to said top, said lid being selectively couplable to each of said plurality of pots, said lid comprising tempered glass, said lid comprising:
an annular rim, said annular rim being threaded, said annular rim being complementary to said first threaded sections of said plurality of pots,
a side face extending upwardly from said annular rim, said side face being arcuate, and
an upper face coupled to and extending inwardly from said side face;
a second handle coupled to said lid, wherein said second handle is positioned on said lid such that said second handle is configured for grasping in a hand of a user such that said lid is rotatable relative to said top of a respective said pot such that said lid is coupled to said respective said pot, said second handle comprising an arm, said arm having opposing ends, each said opposing end being coupled to said lid, said arm being arcuate, said second handle being substantially centrally positioned on said upper face of said lid;
a first insert complementary to said top, said first insert comprising an annular lip and a plate, said plate being coupled to a upper edge of said annular lip, said plate comprising a plurality of penetrations, wherein said top is positioned for inserting said first insert into a respective said pot such that said annular lip is positioned for resting on said bottom of said respective said pot, wherein said plate is positioned above said bottom in substantial parallelism with said bottom, such that said plurality of penetrations are positioned in said plate such that said penetrations are configured to allow steam to pass through said plate;
a second insert complementary to said top, said second insert comprising a plurality of partitions mutually coupled at and extending from a center point of said second insert to a ring defining a plurality of compartments, said ring and said partitions extending from said bottom to proximate to said top of a respective said pot when said second insert is positioned in said respective said pot, wherein said top is positioned for inserting said second insert into a respective said pot such that said second insert rests on said bottom of said respective said pot, wherein said partitions are positioned in said ring such that said second insert is configured for addition of food items into said compartments such that the food items are prevented from mixing, said plurality of partitions comprising four said partitions evenly spaced within said ring;
wherein said first threaded sections of said plurality of pots are positioned such that respective said second threaded sections are positioned to threadedly couple to respective said first threaded sections such that said plurality of pots are mutually coupled in a vertical configuration, wherein said lid is positioned to couple to a respective said first threaded section such that said second handle is configured for the user to lift said plurality of pots.
